(19) United States
(12) Patent Application Publication
(10) Pub. No.: US 2010/0060611 A1
(43) Pub. Date: Mar. 11, 2010

(54) TOUCH DISPLAY WITH SWITCHABLE INFRARED ILLUMINATION FOR TOUCH POSITION DETERMINATION AND METHODS THEREOF

(75) Inventor: Xiangyi Nie, Morrisville, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communication AB

(21) Appl. No.: 12/205,477

(22) Filed: Sep. 5, 2008

(51) Int. Cl. G06F 3/042

(52) U.S. Cl. 345/175

(57) ABSTRACT

An electronic touch display includes a display device, a plurality of light sensors, an infrared light source, a switch circuit, and a touch position circuit. The light sensors are spaced apart and coupled to the display device. The infrared light source is coupled to the display device and configured to emit infrared light through the display device to illuminate an adjacent user object that is touching the display device. The switch circuit is configured to turn on the infrared light source in response to at least one of the light sensors indicating detection of the user object touching the display device. The touch position circuit is configured to identify a user touch position on the display device in response to signal levels from a plurality of the light sensors sensing infrared light from the infrared light source which is reflected by the user object to the plurality of the light sensors.

### FIELD OF THE INVENTION

This invention relates to user interfaces for electronic devices, and more particularly to touch sensing displays for electronic devices such as wireless communication terminals.

### BACKGROUND OF THE INVENTION

Touch sensing displays are becoming a popular interface on electronic devices for users to enter commands and data used in the operation of the device. Touch displays can now be found in mobile telephones, particularly portable music players, PDA (personal digital assistant) devices, and cellular telephones having integrated PDA features and other phone operation related features. The touch displays are generally designed to operate and respond to a finger touch, a stylus touch, or finger/stylus movement on the touch screen surface. Touch displays may be used in addition to, in combination with, or in place of physical keys traditionally used in a cellular phone to carry out the phone functions and features.

Touching a specific point on the touch display may activate a virtual button, feature, or function found or shown at that location on the touch display. Typical phone features which may be operated by touching the display include entering a telephone number, for example, by touching virtual keys of a virtual keyboard shown on the display, making a call or ending a call, bringing tip, adding to or editing and navigating through an address book, and other phone functions such as text messaging, wireless connection to a wide area network, and other phone functions.

Commercial pressures to provide far more functionality within smaller physical device sizes is continuing to drive the need to provide more accurate determination of touch locations on a display under widely varying ambient light conditions.

### SUMMARY OF THE INVENTION

In some embodiments of the present invention, an electronic touch display includes a display device, a plurality of light sensors, an infrared light source, a switch circuit, and a touch position circuit. The light sensors are spaced apart and coupled to the display device. The infrared light source is coupled to the display device and configured to emit infrared light through the display device to illuminate an adjacent user object that is touching the display device. The switch circuit is configured to turn on the infrared light source in response to at least one of the light sensors indicating detection of the user object touching the display device. The touch position circuit is configured to identify a user touch position on the display device in response to signal levels from a plurality of the light sensors sensing infrared light from the infrared light source which is reflected by the user object to the plurality of the light sensors.

The touch position circuit can be configured to respond to the infrared light source being turned on by initiating the identification of the user touch position on the display device.

The touch position circuit can be configured to not carry-out identification of a user touch position on the display device while the infrared light source is turned off.

The switch circuit can be configured to turn on the infrared light source in response to detecting at least a threshold change in amount of ambient light and/or visible light from a backlight that is sensed by at least one of the light sensors.

The switch circuit can be configured to maintain the infrared light source turned on until a first threshold time has elapsed which is sufficient for the touch coordinate position circuit to determine whether or not the user object is touching the display and, when no touching user object is detected, to then turn off the infrared light source.

The switch circuit can be configured to maintain the infrared light source turned on until a second threshold time has elapsed after the touch coordinate position circuit last determined that a user object is touching the display, and to then to turn off the infrared light source.

The switch circuit can be further configured to repetitively cycle power on and off to the infrared light source and to increase the power on to power off duty cycle of the infrared light source in response to at least one of the light sensors indicating detection of the user object touching the display device.

The touch display can further include a backlight device that is coupled to the display device and configured to emit visible light through the display device. The switch circuit can be further configured to trigger the backlight device to power on in response to at least one of the light sensors indicating detection of the user object touching the display device, and to respond to at least one of the light sensors continuing to indicate detection of the user object touching the display device after the backlight is turned on by turning on the infrared light source to enable identification of the user touch position.

The switch circuit can be further configured to turn on the infrared light source in response to a motion signal from a motion sensor that indicates movement of the electronic touch display.

The switch circuit can be further configured to turn on the infrared light source in response to a proximity signal from a proximity sensor that indicates that a user has become proximately located to the electronic touch display.

The switch circuit can be further configured to turn on the infrared light source in response to an alert signal from a wireless communication controller that indicates occurrence of an incoming call and/or incoming message to a wireless communication terminal that is coupled to the electronic touch display.

The infrared light source can include at least one infrared LED that is configured to emit primarily infrared light.

The display device can include a LCD panel with a liquid crystal display layer stacked on a light guide layer. The light sensors can be spaced apart across the LCD panel and the least one infrared LED can be configured to emit infrared light into the light guide for dispersal through and across the LCD panel.

In some other embodiments, a method of operating an electronic touch display can include detecting a touch event on a display device in response to at least one of a plurality of light sensors that are coupled to the display device indicating detection of a user object touching the display device. In response to detecting the touch event, an infrared light source, which is coupled to the display device and configured to emit infrared light through the display device, can be turned on to illuminate the adjacent user object. A user touch position on the display device can be identified in response to signal levels from a plurality of the light sensors sensing infrared light from the infrared light source which is reflected by the user object to the plurality of the light sensors.

Electronic identification of the user touch position on the display device can be prevented until the infrared light source is turned on.

The infrared light source can be turned on in response to detecting at least a threshold change in amount of ambient light and/or visible light emitted by a backlight and that is sensed by at least one of the light sensors.

A backlight device, which is coupled to the display device and configured to emit visible light through the display device, can be turned on in response to at least one of the light sensors indicating detection of the user object touching the display device. The infrared light source can be turned on to enable identification of the user touch position in response to at least one of the light sensors continuing to indicate detection of the user object touching the display device after the backlight device is turned on.

The infrared light source can be turned on in response to a motion signal from a motion sensor that indicates movement of the electronic touch display and/or in response to a proximity signal from a proximity sensor that indicates that a user has become proximately located to the electronic touch display.

The infrared light source can be turned on in response to an alert signal from a wireless communication controller that indicates occurrence of an incoming call and/or incoming message to a wireless communication terminal that is coupled to the electronic touch display.

In some other embodiments, a communications terminal includes a controller, the display device, a plurality of light sensors, an infrared light source, a switch controller, and a touch position circuit. The controller is configured to generate an alert signal in response to an incoming wireless call and/or incoming wireless message to the communications terminal. The light sensors are spaced apart and coupled to the display device. The infrared light source is coupled to the display device and configured to emit infrared light through the display device to illuminate an adjacent user object that is touching the display device. The switch circuit is configured to turn on the infrared light source in response to at least one of the light sensors indicating detection of the user object touching the display device and/or in response to the alert signal. The touch position circuit is configured to identify a user touch position on the display device in response to signal levels from a plurality of the light sensors sensing infrared light from the infrared light source which is reflected by the user object to the plurality of the light sensors.

Other touch displays, circuits, methods, and/or computer program products according to embodiments of the invention will be or become apparent to one with skill in the art upon review of the following drawings and detailed description. It is intended that all such additional displays, circuits, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1A is a block diagram of a touch display with an infrared LED that is powered off before a touch event is detected using ambient light and/or visible backlight according to some embodiments of the present invention;

FIG. 1B is a block diagram of the touch display of FIG. 1A with the infrared LED powered on in response to detection of a touch event using ambient light and/or visible backlight in accordance with some embodiments of the present invention;

FIG. 2 is a flowchart of operations that may be carried out by the touch panel display of FIGS. 1A-1B to control power to the infrared LED according to some embodiments of the present invention;

FIG. 3 is a block diagram of a wireless communications terminal including a touch display and an associated application functionality controller according to some embodiments of the present invention; and

FIG. 4 is a flowchart of operations that may be carried out by the touch panel display of FIG. 3 to control power to the infrared light source according to some embodiments of the present invention.

### DETAILED DESCRIPTION OF PREFERRED EMBODIMENTS

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions and elements and the distances therebetween may be exaggerated for clarity. Like numbers refer to like elements throughout.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some embodiments may be embodied in hardware (including analog circuitry and/or digital circuitry) and/or in software (including firmware, resident software, micro-code, etc.). Consequently, as used herein, the term “signal” may take the form of a continuous waveform and/or discrete value(s), such as digital value(s) in a memory or register. Furthermore, various embodiments may take the form of a computer program product on a computer-usable or computer-readable storage medium having computer-usable or computer-readable program code embodied in the medium for use by or in connection with an instruction execution system. Accordingly, as used herein, the terms “circuit” and “controller” may take the form of digital circuitry, such as a logic gate array and/or computer-readable program code executed by an instruction processing device(s) (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Although some embodiments of the present invention are described in the context of wireless communication terminals for purposes of illustration and explanation only, the present invention is not limited thereto. It is to be understood that the present invention can be more broadly used in any sort of electronic touch display to identify the location of user touches on a display device.

In accordance with some embodiments, an electronic touch display controls power to an infrared (IR) light source in response to whether sensors have detected what appears to be a user object (e.g., finger, stylus, or other object manipulated by a user) that is touching an associated display device (also called a touch event). The electronic touch display uses the infrared (IR) light from the powered on IR light source to illuminate the adjacent user object and to identify therefrom the user touch position on the display device. Accordingly, the IR light source may be maintained powered off to conserve power until a touch event is detected and, responsive to detecting the touch event, the IR light source can then be turned on to allow accurate determination of the user touch position on the display device.

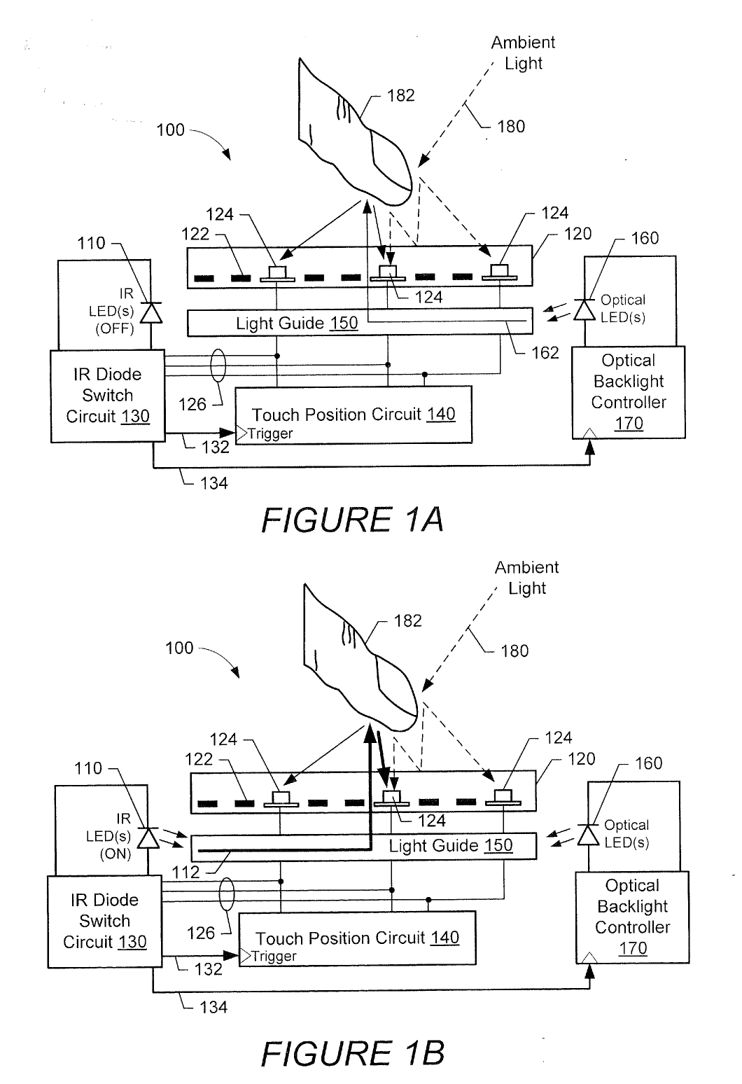

FIG. 1A is a block diagram of a touch display 100 that controls power to an IR light source in response to detection of a touch event. Referring to FIG. 1A, the touch display includes a liquid crystal display (LCD) panel 120, at least one IR LED 110, a switch circuit 130, and a touch position circuit 140. The touch display 100 may further include a light guide 150, at least one backlight optical LED 160, and an optical backlight controller 170.

The LCD panel 120 can include a plurality of LCD elements 122 (e.g., transistors) coupled to a LCD controller (not shown) that controls electric fields generated by the LCD elements 122 to regulate alignment of adjacent liquid crystal material and, thereby, regulate the transmissibility of light through that portion of the LCD panel 120. A plurality of light sensors 124 can be spaced apart across the LCD panel 120 (e.g., arranged in a grid of rows and columns), and may be interposed between groups of the LCD elements 122 as shown in FIG. 1A. The light sensors 124 generate signals 126 having magnitudes that vary in response to the amount of incident light thereto. The touch position circuit 140 determines from the relative magnitudes of the signals 126 where a user object is touching the LCD panel 120.

For example, ambient light 180 striking a user's finger 182 can cast a shadow on the adjacent light sensors 124, resulting in different magnitude signals 126 from the shadowed and non-shadowed light sensors 124. The touch position circuit 140 can determine from the relative magnitudes of the signals 126 what location (e.g., X and Y coordinate positions) on the LCD panel 120 has been touched by the finger 182. Although there may be sufficient contrast between shadowed in non-shadowed light sensors 124 to allow accurate detection of a touch position when the LCD panel 120 is subjected to direct sunlight, the contrast may be insufficient when the LCD panel 120 is located in a poorly lit room.

By using the backlight optical LED(s) 160 to illuminate the finger 182, the touch position circuit 140 may be able to detect the touch location under some circumstances independent of the strength of the ambient light 180. The backlight optical LED(s) 160 are configured to emit optical light 162 (i.e., within the human visual wavelength range) that is coupled into the light guide 150, where it is dispersed in a conventional manner across the LCD panel 120 and passes through the LCD panel 120 depending upon the transmissibility of the liquid crystal material adjacent to the LCD elements 122.

In the illustration of FIG. 1A, the optical light 162 passing through the LCD panel 120, illuminates the finger 182, and is reflected therefrom to the adjacent light sensors 124. The touch position circuit 140 uses the signals 126 from the light sensors 124 illuminated by the reflected optical light 162 to identify a touch location on the LCD panel 120.

Because the LCD elements 122 control the amount of optical light 162 that passes through the LCD panel 120, when the LCD elements 122 are being regulated to display a dark image on the LCD panel 120, the finger 182 may be insufficiently illuminated by the optical light to enable the touch position circuit 140 to accurately determine the touch location from the signals 126.

The challenges of using ambient light and/or backlighting to detect the touch location on the LCD panel 120 may be at least partially overcome by using the IR LED(s) 110 to illuminate the user touch object. As shown in FIG. 1B, the IR LED(s) 110 emit IR light 112 that is coupled into the light guide 150, dispersed across the LCD panel 120, and passed through the LCD panel 120. Because the LCD elements 122 are configured to primarily block optical wavelength light, not IR wavelength light, the IR light 112 from the IR LED(s) can pass through the LCD elements 122 more independently of the optical transmissibility of the LCD elements 122. The light sensors 124 can be configured to output the respective light signals 126 indicating the strength of the IR light that is reflected from the finger 182. The touch position circuit 140 can thereby determine the touch location on the LCD panel 120 in response to the relative magnitudes of the signals from the light sensors 124 which are illuminated by the IR light 112.

Various embodiments of the present invention may arise from the present further realization that the IR LED(s) 110 can consume a sufficient amount of power, and that continuous operation of the IR LED(s) 110 may substantially reduce the operational life of the touch display 100 when operating from a battery power source. In accordance with some embodiments, the switch circuit 130 is configured to turn on the IR LED(s) 110 in response to at least one of the light sensors 124 indicating that a user object is touching the LCD panel 120.

For example, while the switch circuit 130 maintains the IR LED(s) 110 powered off, the finger 182 may cast a shadow from the ambient light 182 and/or the optical backlight 162 onto a plurality of the light sensors 124, which can trigger the switch circuit 130 to detect a touch event and, responsive thereto, to turn on the IR LED(s) 110. Accordingly, although the ambient light 180 and/or optical backlight 162 may be insufficient to enable the touch position circuit 140 to accurately determine the touch location, such light can be sufficient to more coarsely identify the occurrence of a touch condition when the finger 182 is proximately located to the LCD panel 120. The switch circuit 130 can respond to at least a threshold change in an amount of ambient light and/or visible backlight sensed by at least one of the light sensors 124 by turning on the IR LED(s) 110 to illuminate the finger 182 and enable the touch position circuit 140 to accurately determine the touch location on the LED panel 120.

Although only a few LCD elements 122 and light sensors 124 have been illustrated in FIGS. 1A and 1B and their relative sizes have been exaggerated relative to each other and the finger 182 for ease of illustration and explanation, the invention is not limited thereto. It is to be understood that any number of LCD elements 122 and light sensors 124 may be used according to various embodiments of the present invention. Indeed, the LCD panel 120 may include millions of LCD elements 122 depending upon the desired image resolution of the display device 100, and it may include hundreds of light sensors 124 depending upon the desired touch location determination accuracy. Moreover, although some embodiments are described in the context of detecting touch locations on a LCD type of display device, the invention is not limited thereto, as it may be applied to other types of display devices, including without limitation cathode-ray tube (CRT) and/or plasma displays.

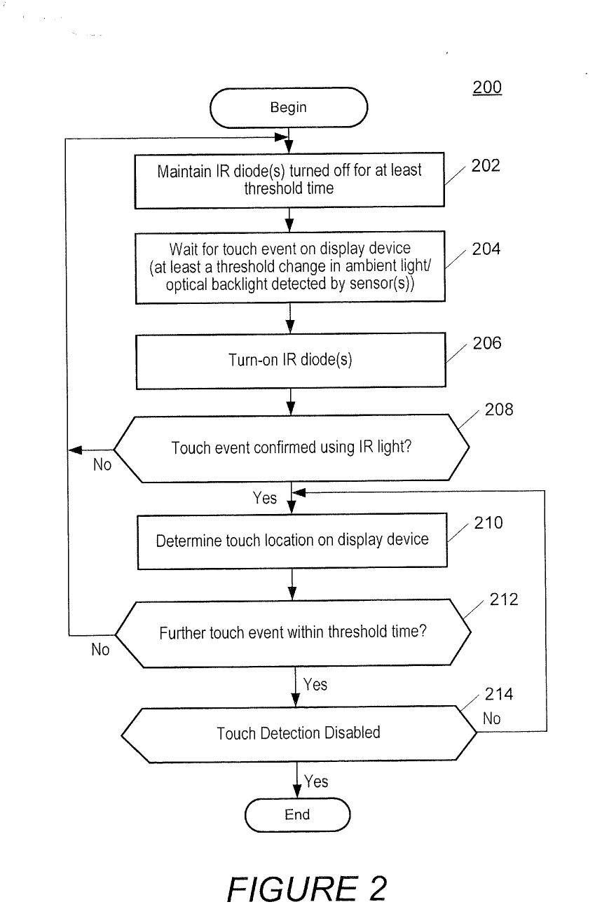

FIG. 2 is a flowchart of operations that may be carried out by the touch panel display of FIGS. 1A-1B to control power to the IR LED(s) 110 according to some embodiments of the present invention. Referring to FIG. 2, at block 202, the switch circuit 130 may maintain the IR LED(s) 110 turned off until a touch event is sensed, or it may repetitively (e.g., periodically) cycled the IR LED(s) 110 on and off to repetitively check for occurrence of a touch event. In response to detecting a touch event (block 204), such as in response to detecting at least a threshold change in the ambient light/visual backlight sensed by one or more light sensors 124, the switch circuit 130 can turn on/maintain on (block 206) the IR LED(s) 110. The switch circuit 130 may identify occurrence of a touch event in response to detecting at least a threshold change in the ambient light and/or visual backlight that is sensed by a single one of the light sensors 124 or by a defined group of a plurality of physically adjacent light sensors 124. Accordingly, although the signal from individual ones of the light sensors 124 may not provide a sufficiently accurate indication of a touch event, the switch circuit 130 may be configured to combine a plurality of the signals 126 from physically adjacent light sensors 124 to form a combined signal that may be used to more accurately identify the occurrence of a touch event.

While the IR LED(s) 110 is turned on, the touch position circuit 140 attempts to confirm the occurrence of a touch event in response to the signals 126 (block 208). When a touch event is not confirmed using the IR light, the switch circuit 130 can turn off the IR LED(s) 110 and, thereby, conserve power. In contrast, when occurrence of the touch event is confirmed using the IR light, the touch position circuit 140 can determine (block 210) the location of the touch on the LCD panel 120, such as by identifying row and column coordinate locations where the LCD panel 120 is being touched. Accordingly, the switch circuit 130 may maintain the IR LED(s) 110 turned on until a threshold time has elapsed which is sufficient for the touch position circuit 140 to determine whether or not a user object is touching the LCD panel 120 and, when no touching is detected, it may then turn off the IR LED(s) 110.

The switch circuit 130 may generate a signal 132 that triggers the touch position circuit 140 to initiate identification of the user touch position on the LCD panel 120. Thus, the touch position circuit 140 may be configured to not carryout identification of the user touch position until the switch circuit 130 has turned on the IR LED(s) 110 and triggered identification of the touch position via the signal 132. Because the IR light from the IR LED(s) 110 may provide more uniform illumination of an object touching the LCD panel 120 independent of the ambient light conditions and/or the effects of the transmissibility of light through the LCD elements 122, inhibiting identification of the user touch position until the IR LED(s) 110 has been turned on may improve the accuracy of the detected touch location and/or may reduce/avoid detection of false touches due to shadows caused by other variations in ambient light and/or transmissibility of the LCD elements 122.

In some further embodiments, the switch circuit 130 may generate another signal 134 in response to at least one of the light sensors 124 or a defined group of the light sensors 124 indicating detection of a touch event. The signal 134 can trigger the optical backlight controller 170 to turn on the optical backlight LED(s) 160 and, thereby, attempt to further illuminate an adjacent user object. The switch controller 130 can then turn on the IR LED(s) 110 in response to at least one of the light sensors 124 or a defined group of the light sensors 124 continuing to indicate detection of the user object touching the LCD panel 120 after the optical backlight LED(s) 160 has been turned on. The first level of illumination provided by the optical backlight can thereby be used to confirm that a touch has occurred, while the second level of illumination provided by the IR light can be used to detect the location of the touch.

After the touch position circuit 140 has last determined that a user object is touching the LCD panel 120, the switch circuit 130 may maintain the IR LED(s) 110 turned on for a further threshold time (block 212) to assist with detecting a further touch event. When no further touch event is detected within that threshold time, the switch circuit 130 may turn off the IR LED(s) 110 (block 202). Otherwise, when a further touch event is detected and detection of touches has not been disabled (block 214), the switch circuit 130 can extend the power on cycle of the IR LED(s) 110 while the touch position circuit 140 determines subsequent locations of the touching object (block 210).

Alternatively or additionally, the switch circuit 130 may repetitively cycle power on and off to the IR LED(s) 110 and may increase the power on to power off duty cycle of the IR LED(s) 110 in response to at least one of the light sensors 124 or a defined group of the light sensors 124 indicating detection of a user object touching the LCD panel 120.

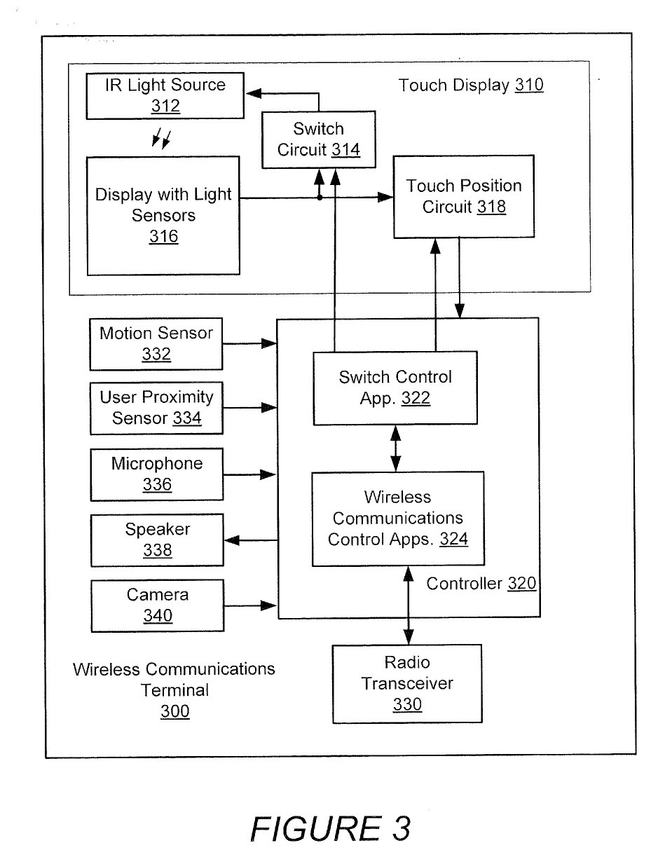

FIG. 3 is a block diagram of an exemplary wireless communications terminal 300 that includes a touch display 310 that includes a switchable IR light source which is turned on in response to detecting a touch event, and which is used to detect a location of a user object touching the touch display 310. The terminal 300 further includes a controller 320, a radio transceiver 330, a motion sensor 332, a user proximity sensor 334, a microphone 336, a speaker 338, and a camera 340. The touch display 310 includes an IR light source 312 (e.g. the IR LED(s) 110), a display with light sensors 316 (e.g., the LCD panel 120), a switch circuit 314, and a touch position circuit 318. The touch position circuit 318 may operate as described above for the touch position circuit 140 of FIGS. 1A and 1B.

The controller 320 (e.g., a microprocessor) executes various application programs, such as the illustrated switch control application 322 and the wireless communication applications 324. Although the applications 322 and 324 have been shown as being carried out by a single controller, it is to be understood that their functionality may instead be carried out by more than one controller (e.g., by a DSP and a general processor) and/or by a combination of analog and digital hardware.

The wireless communication applications 324 are configured to communicate through the radio transceiver 330 over a wireless air interface with one or more RF transceiver base stations and/or other wireless communication terminals using one or more wireless communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, and/or HIPERMAN, wireless local area network (e.g., 802.11), and/or Bluetooth.

The wireless communication applications 324 may be configured to carry out wireless communications functionality, such as conventional cellular phone functionality including, but not limited to, voice/video telephone calls and/or data messaging such as text/picture/video messaging. The wireless communication applications 324 and/or other functionality of the terminal 300 can be operated in responsive to the user touch positions identified by the touch position circuit 318.

For example, touching a specific point on the display 316 may activate a virtual button, feature, or function associated with or shown at that location on the display 316. Various exemplary phone features that may be activated in the communications control applications 324 by touching the display 316 can include entering a telephone number, for example, by touching virtual keys of a virtual keyboard shown on the display, making and receiving calls, editing and navigating an address book, and/or other communications functionality such as creating and receiving text messages and navigating to various network addresses across a wide area data network (e.g., Internet).

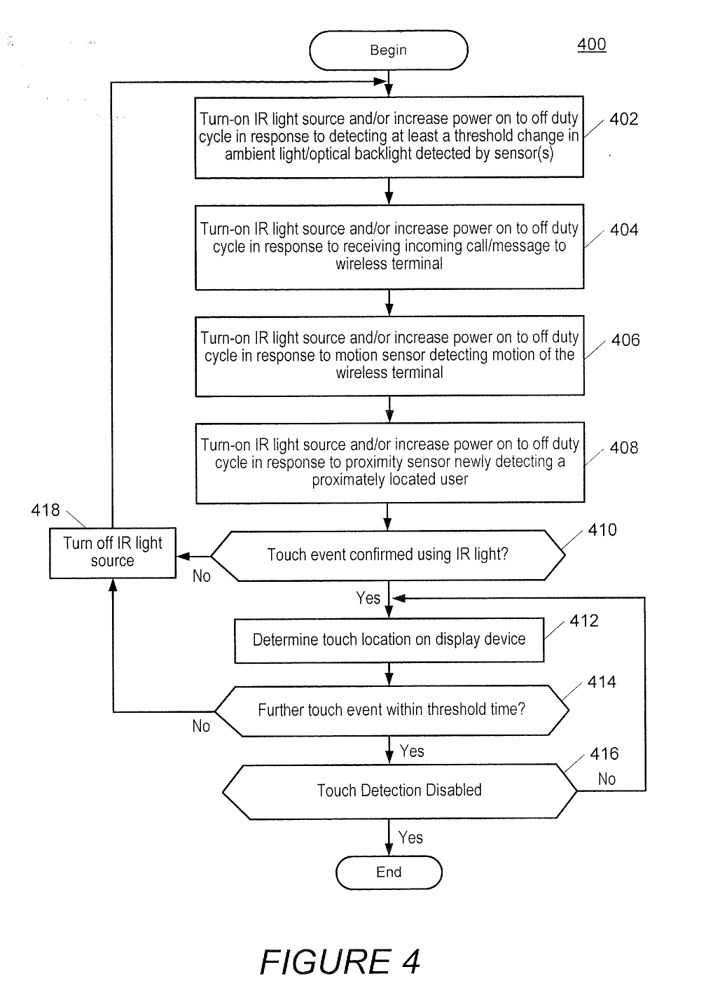

The switch circuit 314 controls the flow of power to the IR light source 312 in response to a control signal from the switch control application 322. FIG. 4 is a flowchart of operations that may be carried out by the switch control application 322 to control power to the infrared light source 312 according to some embodiments of the present invention.

Referring to FIG. 4, the switch control application 322 can be configured (block 402) to trigger the switch circuit 314 to turn on the IR light source 312 and/or to increase the power on to power off duty cycle of the light source 312 in response to detecting at least a threshold change in ambient light and/or optical backlight detected by the light sensors in the display 316.

The switch control application 322 may be configured (block 404) to trigger the switch circuit 314 to turn on the IR light source 312 and/or to increase the power on to power off duty cycle of the light source 312 in response to an alert signal from the wireless communications application 324 indicating that an incoming call and/or an incoming message is being received by the wireless terminal 300.

The switch control application 322 may be configured (block 406) to trigger the switch circuit 314 to turn on the IR light source 312 and/or to increase the power on to power off duty cycle of the light source 312 in response to the motion sensor 332 detecting motion of the wireless terminal 300. The motion sensor 332 may, for example, include one or more accelerometers.

The switch control application 322 may be configured (block 408) to trigger the switch circuit 314 to turn on the IR light source 312 and/or to increase the power on to power off duty cycle of the light source 312 in response to the proximity sensor 334 detecting a proximately located user. The proximity sensor 334 may, for example, include another IR light source that is configured to illuminate an area that external to a housing of the wireless terminal 300, and include a light sensor that is configured to sensed IR light that is reflected to the housing as a user approaches the terminal 300.

The switch controller application 322 further operates in a similar manner to that described for the switch circuit 130 of FIGS. 1A, 1B, and 2 to use the IR light from the turned on IR light source 312 to confirm that a touch event is occurring (block 410) and, responsive to the confirmation, to cause the touch position circuit 318 to determine (block 412) the location on the display 316 of the touch.

When a further touch event is not detected within a threshold time (block 414) and/or when the touch event is not confirmed (block 410) using the IR light, the switch control application 322 can turn off (block 418) the IR light source 312. When touch detection is not presently disabled (block 416), the switch control application 322 can maintain the IR light source 312 turned on to enable continued determination by the touch position circuit 310 of further touch positions on the display 316 (block 412).

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An electronic touch display comprising:
a display device;
a plurality of light sensors spaced apart and coupled to the display device;
an infrared light source coupled to the display device and configured to emit infrared light through the display device to illuminate an adjacent user object that is touching the display device;
a switch circuit that is configured to turn on the infrared light source in response to at least one of the light sensors indicating detection of the user object touching the display device; and
a touch position circuit that is configured to identify a user touch position on the display device in response to signal levels from a plurality of the light sensors sensing infrared light from the infrared light source which is reflected by the user object to the plurality of the light sensors.

2. The electronic touch display of claim 1, wherein:
the touch position circuit is configured to respond to the infrared light source being turned on by initiating the identification of the user touch position on the display device.

3. The electronic touch display of claim 1, wherein:
the touch position circuit is configured to not carry-out identification of a user touch position on the display device while the infrared light source is turned off.

4. The electronic touch display of claim 1, wherein:
the switch circuit is configured to turn on the infrared light source in response to detecting at least a threshold change in amount of ambient light and/or visible light from a backlight that is sensed by at least one of the light sensors.

5. The electronic touch display of claim 1, wherein:
the switch circuit is configured to maintain the infrared light source turned on until a first threshold time has elapsed which is sufficient for the touch coordinate position circuit to determine whether or not the user object is touching the display and, when no touching user object is detected, to then turn off the infrared light source.

6. The electronic touch display of claim 5, wherein:
the switch circuit is configured to maintain the infrared light source turned on until a second threshold time has elapsed after the touch coordinate position circuit last determined that a user object is touching the display and then to turn off the infrared light source.

7. The electronic touch display of claim 1, wherein:
the switch circuit is further configured to repetitively cycle power on and off to the infrared light source and to increase the power on to power off duty cycle of the infrared light source in response to at least one of the light sensors indicating detection of the user object touching the display device.

8. The electronic touch display of claim 1, further comprising a backlight device that is coupled to the display device and configured to emit visible light through the display device, wherein the switch circuit is further configured to trigger the backlight device to power on in response to at least one of the light sensors indicating detection of the user object touching the display device, and to respond to at least one of the light sensors continuing to indicate detection of the user object touching the display device after the backlight is turned on by turning on the infrared light source to enable identification of the user touch position.

9. The electronic touch display of claim 1, wherein:
the switch circuit is further configured to turn on the infrared light source in response to a motion signal from a motion sensor that indicates movement of the electronic touch display.

10. The electronic touch display of claim 1, wherein:
the switch circuit is further configured to turn on the infrared light source in response to a proximity signal from a proximity sensor that indicates that a user has become proximately located to the electronic touch display.

11. The electronic touch display of claim 1, wherein:
the switch circuit is further configured to turn on the infrared light source in response to an alert signal from a wireless communication controller that indicates occurrence of an incoming call and/or incoming message to a wireless communication terminal that is coupled to the electronic touch display.

12. The electronic touch display of claim 1, wherein:
the infrared light source comprises at least one infrared LED configured to emit primarily infrared light.

13. The electronic touch display of claim 12, wherein:
the display device comprises a LCD panel with a liquid crystal display layer stacked on a light guide layer, wherein the light sensors are spaced apart across the LCD panel and the least one infrared LED is configured to emit infrared light into the light guide for dispersal through and across the LCD panel.

14. A method of operating an electronic touch display, the method comprising:
detecting a touch event on a display device in response to at least one of a plurality of light sensors that are coupled to the display device indicating detection of a user object touching the display device;
in response to detecting the touch event, turning on an infrared light source that is coupled to the display device and configured to emit infrared light through the display device to illuminate the adjacent user object; and
identifying a user touch position on the display device in response to signal levels from a plurality of the light sensors sensing infrared light from the infrared light source which is reflected by the user object to the plurality of the light sensors.

15. The method of claim 14, further comprising:
preventing electronic identification of the user touch position on the display device until the infrared light source is turned on.

16. The method of claim 14, wherein the infrared light source is turned on in response to detecting at least a threshold change in amount of ambient light and/or visible light emitted by a backlight and that is sensed by at least one of the light sensors.

17. The method of claim 14, further comprising:
turning on a backlight device, which is coupled to the display device and configured to emit visible light through the display device, in response to at least one of the light sensors indicating detection of the user object touching the display device; and
turning on the infrared light source to enable identification of the user touch position in response to at least one of the light sensors continuing to indicate detection of the user object touching the display device after the backlight device is turned on.

18. The method of claim 14, further comprising:
turning on the infrared light source in response to a motion signal from a motion sensor that indicates movement of the electronic touch display and/or in response to a proximity signal from a proximity sensor that indicates that a user has become proximately located to the electronic touch display.

19. The method of claim 14, further comprising:
turning on the infrared light source in response to an alert signal from a wireless communication controller that indicates occurrence of an incoming call and/or incoming message to a wireless communication terminal that is coupled to the electronic touch display.

20. A communications terminal comprising:
a controller that is configured to generate an alert signal in response to an incoming wireless call and/or incoming wireless message to the communications terminal;
a display device;
a plurality of light sensors spaced apart and coupled to the display device;
an infrared light source coupled to the display device and configured to emit infrared light through the display device to illuminate an adjacent user object that is touching the display device;
a switch circuit that is configured to turn on the infrared light source in response to at least one of the light sensors indicating detection of the user object touching the display device and/or in response to the alert signal; and
a touch position circuit that is configured to identify a user touch position on the display device in response to signal levels from a plurality of the light sensors sensing infrared light from the infrared light source which is reflected by the user object to the plurality of the light sensors.
